(19) United States
(12) Patent Application Publication
(10) Pub. No.: US 2026/0239070 A1
(43) Pub. Date: Aug. 13, 2026

(54) Beam Reporting Associated With Multiple Beam Resource Sets

(71) Applicant: InterDigital Patent Holdings, Inc., Wilmington, DE (US)

(72) Inventors: Prasanna Herath, Laval (CA); Young Woo Kwak, Woodbury, NY (US); J. Patrick Tooher, Montreal (CA); Moon-il Lee, Melville, NY (US); Yugeswar Deenoo Narayanan Thangaraj, Chalfont, PA (US); Ahmed Mostafa, Ottawa (CA); Nazli Khan Beigi, Longueuil (CA); Tejaswinee Lutchoomun, Montreal (CA); Haseeb Ur Rehman, Winnipeg (CA)

(73) Assignee: InterDigital Patent Holdings, Inc., Wilmington, DE (US)

(21) Appl. No.: 19/154,649

(22) PCT Filed: Feb. 7, 2024
(86) PCT No.: PCT/US2024/014844

§ 371 Date: Aug. 7, 2025

Related U.S. Application Data
(60) Provisional application No. 63/443,907, filed on Feb. 7, 2023.

(51) Int. Cl. H04W 24/10; H04B 17/318; H04L 5/00

(52) U.S. Cl. CPC H04W 24/10; H04B 17/328; H04L 5/0048

(57) ABSTRACT

Systems, methods, devices, and instrumentalities are described herein related to beam reporting associated with multiple beam resource sets. A wireless transmit/receive unit (WTRU) may receive configuration information. The configuration information may include a first number of RS resource sets and an RS resource set selection criterion. The WTRU may receive an indication for selecting a second number of RS resource sets from the first number of RS resource sets for measurement reporting based on the RS resource set criterion. The WTRU may report a first measurement type for the second number of RS resource sets and a second measurement type for a third number of RS resource sets. The third number of RS resource sets may be an unselected number of the first number of RS resource sets.

### CROSS-REFERENCE TO RELATED APPLICATIONS

This application claims the benefit of Provisional U.S. Patent Application No. 63/443,907, filed Feb. 7, 2023, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, devices, and instrumentalities are described herein related to beam reporting associated with multiple beam resource sets.

A wireless transmit/receive unit (WTRU) may receive configuration information. The configuration information may include a first number of RS resource sets and an RS resource set selection criterion. The WTRU may receive an indication for selecting a second number of RS resource sets from the first number of RS resource sets for measurement reporting based on the RS resource set criterion. The WTRU may perform RS measurements for the first number of RS resource sets. The WTRU may select the second number of RS resource sets for measurement reporting based on the RS resource set criterion.

In examples, the RS resource set criterion may include selecting the second number RS resource sets based on the second number of RS resource sets including at least one RS resource with a maximum measurement value. In examples, the RS resource set criterion may include selecting the second number RS resource sets based on the second number of RS resource sets having an average measurement value that exceeds a preconfigured threshold.

The WTRU may report a first measurement type for the second number of RS resource sets and a second measurement type for a third number of RS resource sets. The third number of RS resource sets may be an unselected number of the first number of RS resource sets.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example variation of an L1-RSRP with elevation and azimuth angles.

FIG. 3 illustrates an example variation of L1-RSRP of beams with time.

FIG. 4 illustrates an example variation of L1-RSRP across different sectors/panels.

### DETAILED DESCRIPTION

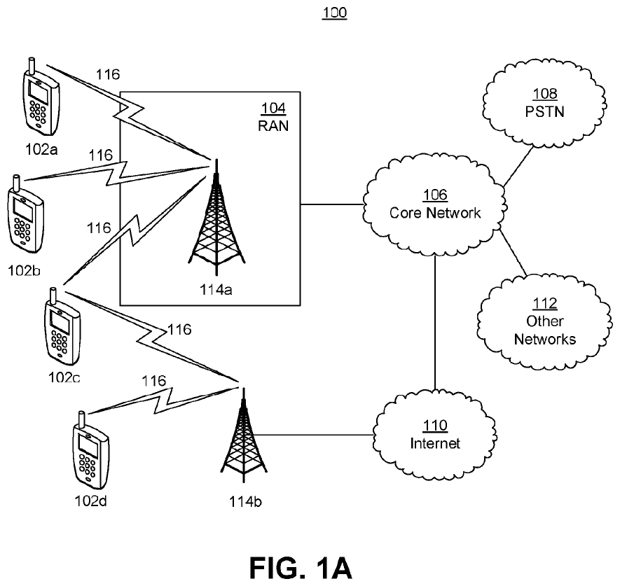

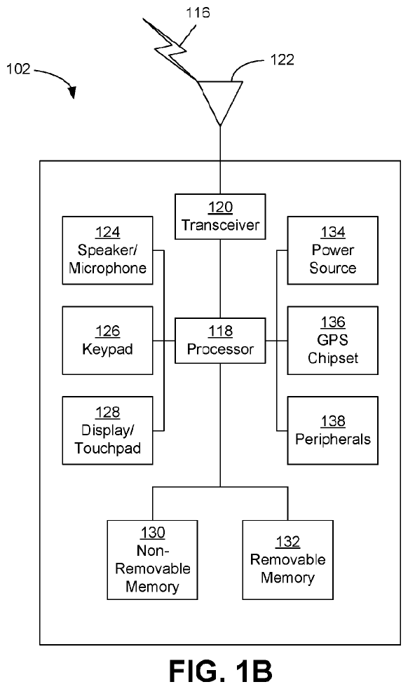

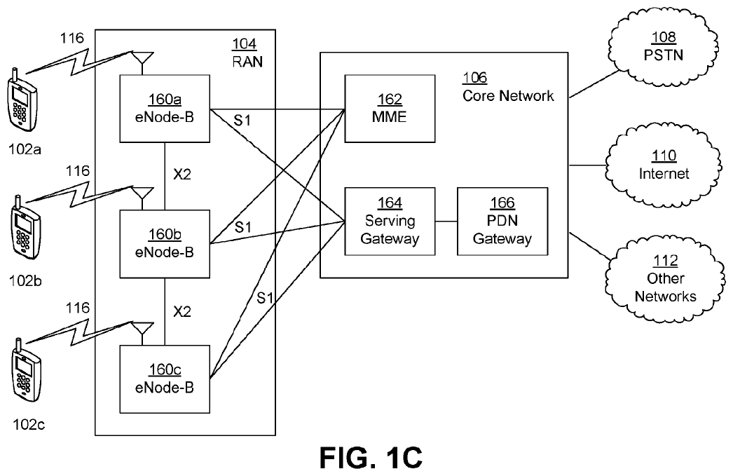

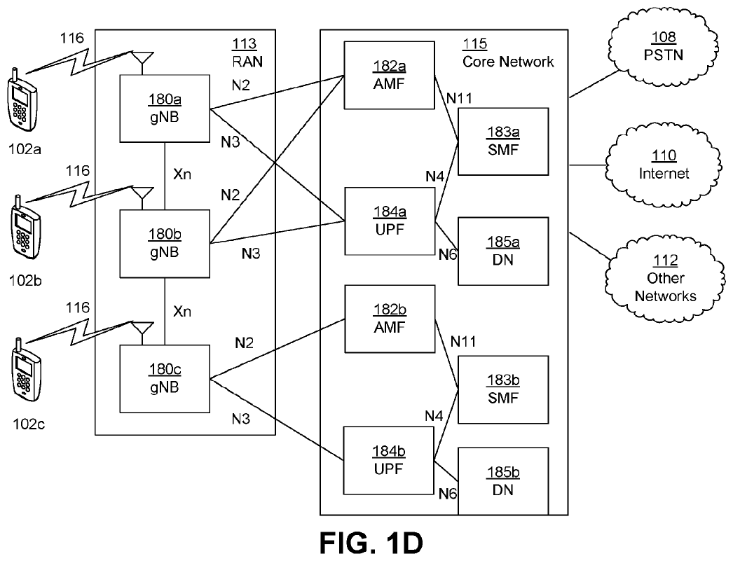

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc.

Systems, methods, devices, and instrumentalities are described herein related to beam reporting associated with multiple beam resource sets.

A wireless transmit/receive unit (WTRU) may receive configuration information. The configuration information may include a first number of RS resource sets and an RS resource set selection criterion. The WTRU may receive an indication for selecting a second number of RS resource sets from the first number of RS resource sets for measurement reporting based on the RS resource set criterion. The WTRU may perform RS measurements for the first number of RS resource sets. The WTRU may select the second number of RS resource sets for measurement reporting based on the RS resource set criterion.

In examples, the RS resource set criterion may include selecting the second number RS resource sets based on the second number of RS resource sets including at least one RS resource with a maximum measurement value. In examples, the RS resource set criterion may include selecting the second number RS resource sets based on the second number of RS resource sets having an average measurement value that exceeds a preconfigured threshold.

The WTRU may report a first measurement type for the second number of RS resource sets and a second measurement type for a third number of RS resource sets. The third number of RS resource sets may be an unselected number of the first number of RS resource sets.

A WTRU may determine a number of reference beams based on beam measurements and/or a network (e.g., network node or gNB) configuration (e.g., configuration information). The WTRU may select reference beams based on a gNB configuration and/or beam measurements. The WTRU may group beams into subsets. The subsets may associate groups to reference beams (e.g., each group to a reference beam). The WTRU may report beam measurements of reference beams and beam IDs. For groups of beams (e.g., for each group of beams), the WTRU may compute and report differential beam measurements based on associated reference beams.

The WTRU may report assistant information for the network node (e.g., gNB) to determine the need for beam measurements (e.g., updated beam measurements) for beam inference or model training.

In examples, for a configured beam resource set, the WTRU may report beam measurements corresponding to multiple time instances by measuring and reporting beam measurements of beams (e.g., all beams) in the resource set that may correspond to a number of k measurement instances (e.g., an initial number of k measurement instances). In examples, for a configured beam resource set, the WTRU may report beam measurements corresponding to multiple time instances by measuring and reporting beam measurements of a subset of selected beams in the resource set (e.g., sparse reporting) for the measurement instances after the kth instance. The WTRU may report beams selected at measurement instances (e.g., each measurement instance) to the gNB.

The WTRU may report beam measurements of a selected measurement instance (e.g., a representative measurement instance) out of configured number of measurement instances (e.g., L measurement instances). The WTRU may report (e.g., additional) measurement and/or computed parameters based on measurements to the gNB (e.g., a maximum measurement of a beam in L measurement instances and the corresponding time instance).

The WTRU may measure beams corresponding to a number of resource sets (e.g., M>1). The WTRU may determine the selected and non-selected beam resource sets for measurement reporting based on a criteria (e.g., criteria X) configured by the gNB. The WTRU may report beam measurements determined by a configured reporting quantity assignment procedure (e.g., procedure Y) for selected and non-selected resource sets (e.g., based on criteria X). In examples, for a selected resource set (e.g., based on criteria X), a WTRU may report measurement(s) (e.g., L1-RSRP) of (e.g., all) the beams based on configured reporting quantity assignment procedure Y. For a non-selected resource set (e.g., based on criteria X), a WTRU may report an average beam measurement (e.g., an average L1-RSRP over all the beams in the resource set) based on configured reporting quantity assignment procedure Y.

The WTRU may select reporting parameters (e.g., a maximum and minimum value of beam measurements, quantization step size, etc.) based on a configuration (e.g., configuration information) or beam measurements. The WTRU may determine and switch value reporting parameters based on a trigger condition and/or a stop condition for accurate reporting. The WTRU may determine a set (e.g., an updated set) of reporting parameters based on a configured fallback procedure (e.g., reduce step-size by one step etc.). The WTRU may determine values of reporting parameters based on required accuracy and/or beam measurements.

Beam measurements and reporting may be essential (e.g., for the proper operation of wireless communications in higher frequencies (e.g., FR2-1, FR2-2)). An NR beam measurement and reporting mechanism may be a high-power consuming and delay causing operation. These mechanisms may (e.g., may further) require high signaling overhead (e.g., for transmitting reference signals and reporting beam measurements). Improvements for beam measurement and reporting may be highly beneficial for wireless systems operating in higher frequencies. AI/ML based examples for improving beam management are provided herein.

An AI/ML model implementation may locate the AI/ML capabilities at a network (e.g., network node or gNB) side. With this setup (e.g., for the model inference and model training), beam measurements may be performed by WTRUs and reported to the gNB side. This process may involve measuring, reporting beams (e.g., many beams which may be more than the number of beams required to be measured), and/or reporting beams at a time according to beam management examples. AI/ML based beam predictions may reduce the overall demand for beam measurements and reporting for at least the following reasons: if beam measurements for the model inference are provided to a trained AI/ML model, the model may predict beam measurements for a long duration of time before requiring new beam measurements; if an AI/ML model is trained, the trained model may be used to predict beams for many WTRUs including WTRUs that have not provided beam measurements for model training; and some of the beam measurements required for model training may not be time critical (e.g., these beam measurements may be reported if the NR air interface is underused or via other means (e.g., beam reports are sent via WLAN)).

During the model inference stage, beam selection with AI/ML models may be based on predictions. This may be faster compared to the existing NR beam selection process that depends on beam measurements reported by the WTRU.

If not properly designed, the need for measuring and reporting large number of beams for beam inference and model training may significantly undermine the advantages of using AI/ML models for beam management. This is particularly crucial if the AI/ML model is located at the gNB side in which the WTRU-gNB air interface may have to be used for beam reporting.

A WTRU may report a CSI-RS resource indicator (CRI) and L1-RSRP of a beam with the highest L1-RSRP of a beam resource set (e.g., in the NR beam reporting framework). The WTRU may report (e.g., additionally report) L1-RSRP measurements of maximum up to three (e.g., additional) beams (as differential L1-RSRPs) and their CRIs. In examples, reporting measurements of a few beams (e.g., L1-RSRP of four beams) may be insufficient for providing beam measurements for model inference and model training if the AI/ML model is located at a network node (e.g., gNB). The number of beams and type of beam measurements to be reported (e.g., in the current CSI framework) may not be dynamically determined based on beam measurements experienced by the WTRU. The type of measurements associated with beams or beam resource sets to be reported may not (e.g., may also not) be dynamically determined based on beam measurements experienced by the WTRU. Supporting such dynamic behaviors may reduce the signaling overhead associated with beam reporting while the AI/ML model receives sufficient beam measurements for model inference and training.

Examples herein may allow a WTRU to report beam measurements of many beams potentially over several time instances with limited signaling overhead. Examples herein may allow beam reporting to be performed with limited signaling overhead while reducing quantization errors in the reported beam measurements. Examples herein may allow a WTRU to dynamically determine beams or beam resource sets for which beam measurements are to be reported. Examples herein allow a WTRU to determine measurement type (e.g., L1-RSRP of each beam, average L1-RSRP of all the beams) associated with a beam resource set or beams to be reported.

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (e.g., such as CSI-RS) or a synchronization signal (SS) block. The WTRU transmission may be referred to as a “target”. The received RS or SS block may be referred to as a “reference” or a “source”. The WTRU may (e.g., in such cases) transmit the target physical channel or signal according to a spatial relation with a reference to such an RS or an SS block.

The WTRU may transmit a first physical channel or signal according to the same spatial domain filter as the spatial domain filter used for transmitting a second physical channel or signal. The first and second transmissions may be referred to as a “target” and a “reference” (or “source”), respectively. The WTRU may be said (e.g., in such cases) to transmit the first (e.g., target) physical channel or signal according to a spatial relation with a reference to the second (e.g., reference) physical channel or signal.

A spatial relation may be implicit, configured by RRC, or signaled by an MAC CE or a DCI. In examples, a WTRU may implicitly transmit a PUSCH and a DM-RS of a PUSCH according to the same spatial domain filter as an SRS indicated by an SRI indicated in a DCI or configured by an RRC. In examples, a spatial relation may be configured by an RRC for an SRS resource indicator (SRI) or signaled by an MAC CE for a PUCCH. Such spatial relation may (e.g., may also) be referred to as a “beam indication”.

The WTRU may receive a first (e.g., target) downlink channel or signal according to the same spatial domain filter or spatial reception parameter as a second (e.g., reference) downlink channel or signal. In examples, an association may exist between a physical channel such as a PDCCH or a PDSCH and its respective DM-RS. In examples, an association may exist if the WTRU is configured with a quasi-colocation (QCL) assumption type D between corresponding antenna ports (e.g., at least if the first and second signals are reference signals). Such association(s) may be configured as a transmission configuration indictor (TCI) state. A WTRU may be indicated as an association between a CSI-RS or SS block and a DM-RS by an index to a set of TCI states configured by an RRC and/or signaled by an MAC CE. Such an indication may (e.g., may also) be referred to as a “beam indication”.

Examples of beam measurement, beam quality measurement, and/or beam quality are provided herein. Beam measurement, beam quality measurement, and/or beam quality may refer to one or more of the following parameters measured, estimated, and/or derived based on measurements performed for a beam or set of beams: a reference signal received power (RSRP); a reference signal received quality (RSRQ); a received signal strength indicator (RSSI), a signal-to-interference-plus-noise ratio (SINR); a channel quality indicator (CQI); a rank indicator (RI); a layer indicator (LI); a precoding matrix indicator (PMI); a CRI; an angle of arrival (AoA); an angle of departure (AoD); a doppler spread; a doppler shift; an average doppler; a delay spread; an average delay; or a channel occupancy.

Differential beam measurement or spatial-domain differential beam measurement of two beams may be the difference between the two beam measurements. In examples, spatial-domain differential L1-RSRP of two beams may be the difference between L1-RSRPs of the two beams.

Time-domain differential beam measurement of a beam may be the difference between beam measurements of the same beam at two time instances. In examples, the time-domain differential L1-RSRP of a beam may be the difference between L1-RSRPs of the beam at two time instances.

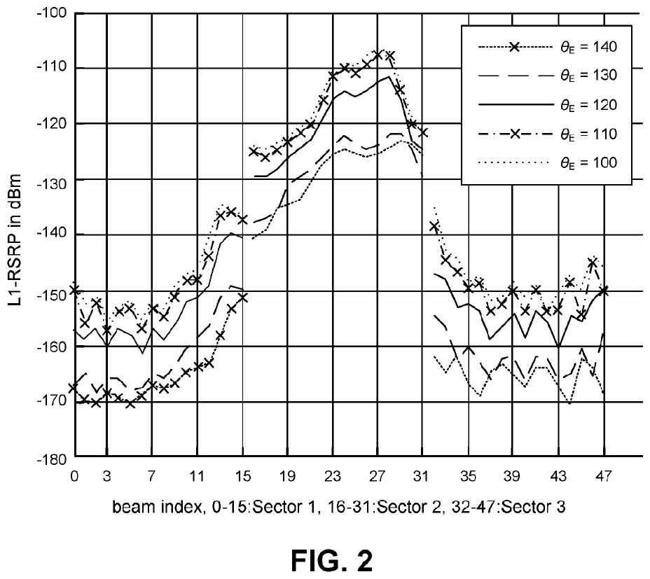

FIG. 2 illustrates an example variation of an L1-RSRP with elevation and azimuth angles. Simulated L1-RSRPs results of different downlink beams (corresponding to different azimuth and elevation angles) experienced by a typical WTRU are shown in FIG. 2. The relationship between the beam indices and azimuth angles are given in Table 1 below.

TABLE 1
Relationship between beam indices and azimuth and elevation angles

| | Azimuth angle in degrees relative to boresight of an antenna panel. Each antenna | | | | | | | | | | | | | | | |
|---|---|---|---|---|---|---|---|---|---|---|---|---|---|---|---|---|
| | panel provide coverage to non-overlapping 120 degrees in the azimuth plane. | | | | | | | | | | | | | | | |
| | −55 | −45 | −35 | −25 | −20 | −15 | −10 | −55 | −55 | −10 | −15 | −20 | −25 | −35 | −45 | −55 |
| Beam index for | 0 | 1 | 2 | 3 | 4 | 5 | 6 | 7 | 8 | 9 | 10 | 11 | 12 | 13 | 14 | 15 |
| antenna panel 1 | | | | | | | | | | | | | | | | |
| Beam index for | 16 | 17 | 18 | 19 | 20 | 21 | 22 | 23 | 24 | 25 | 26 | 27 | 28 | 29 | 30 | 31 |
| antenna Panel 2 | | | | | | | | | | | | | | | | |
| Beam index for | 32 | 33 | 34 | 35 | 36 | 37 | 38 | 39 | 40 | 41 | 42 | 43 | 44 | 45 | 46 | 47 |
| antenna panel 3 | | | | | | | | | | | | | | | | |

Two beam measurements (e.g., L1-RSRP) of beams with similar azimuth and elevation angles originated from the same panel or sector antennas may be correlated.

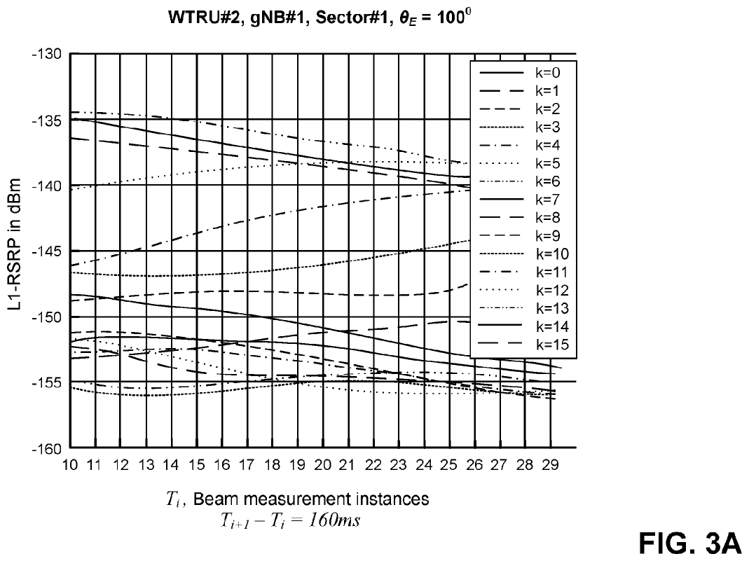

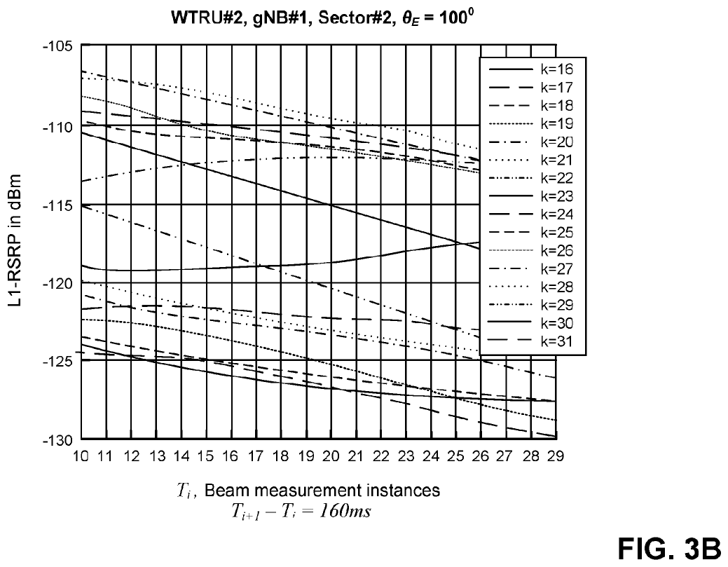

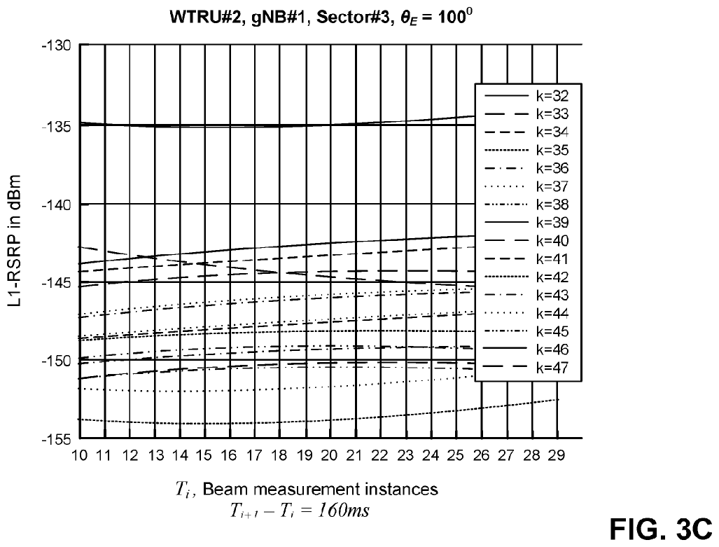

FIG. 3 illustrates an example variation of L-RSRP of beams with time. The variation of L1-RSRPs of different downlink beams (corresponding to different azimuth and elevation angles) with time is shown in FIG. 3. The relationship between the beam indices and azimuth angles are given above in Table 1.

Beam measurements (e.g., L1-RSRP) of a beam at two adjacent time instances may be correlated.

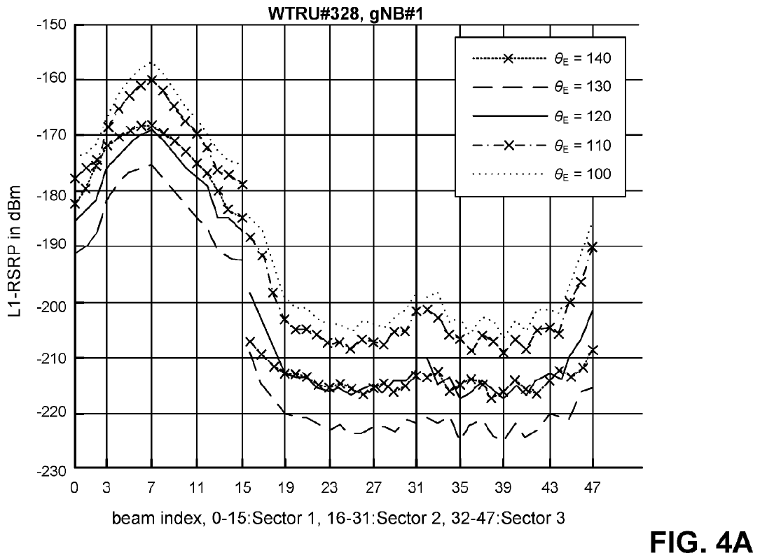

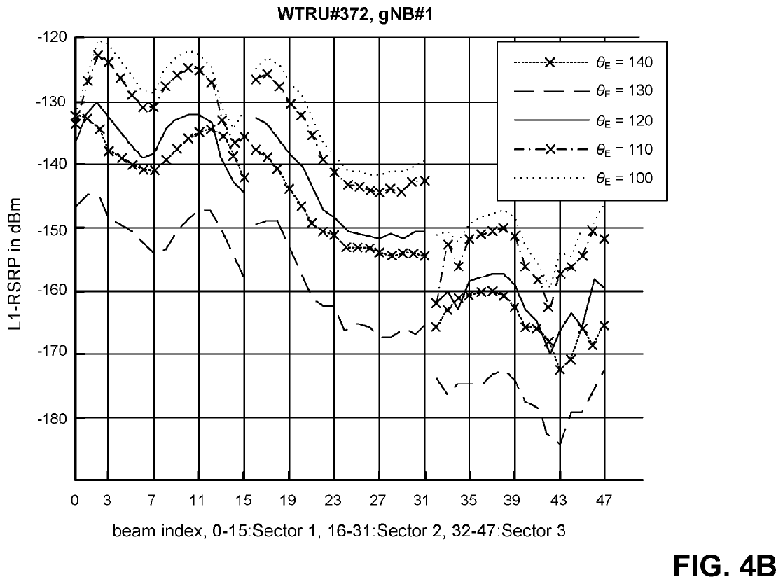

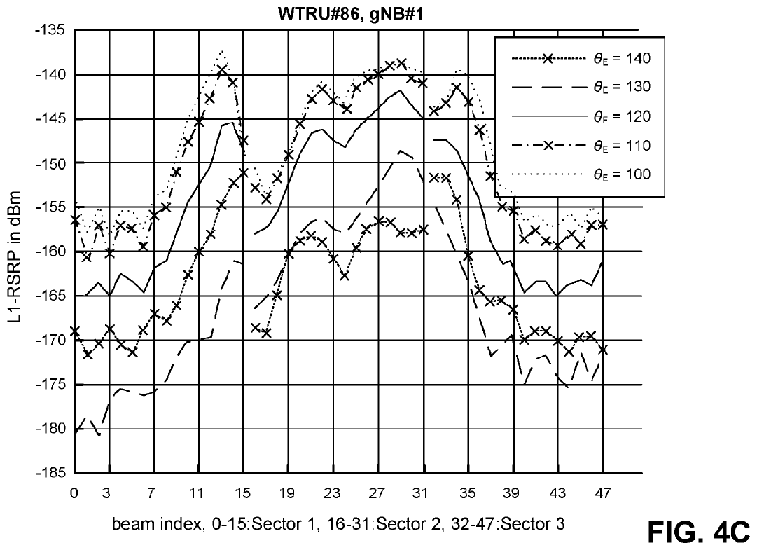

FIG. 4 illustrates an example variation of L1-RSRP across different sectors/panels. Three possible scenarios the WTRUs served by a gNB with three antenna panels (or sectors) may experience are shown in FIG. 4. These include a WTRU that receives better quality beams (e.g., beams corresponding to higher L1-RSRP) from, one out of three panels at the gNB, two out of three panels at the gNB, and all three panels at the gNB. The relationship between the beam indices and azimuth angles are given in Table 1. The same WTRU may (e.g., may also) experience all three scenarios at different times.

The number of antenna panels (or sectors) at the gNB that provide better beams (e.g., beams with higher L1-RSRP) may change from one WTRU to another. The number of antenna panels (or sectors) at the gNB that provide better beams (e.g., beams with higher L1-RSRP) for a WTRU may dynamically be changed.

Examples of configurations for reporting beam measurements are provided herein. A WTRU may receive one or more configurations and/or indications. The WTRU may determine to measure and report one or more beam resources. A beam resource may include one or more of: a TCI state, an SSB, a CSI-RS, a PT-RS, or a TRS for downlink. The beam resource may include one or more of: an SRS resource, or TCI state for uplink.

In examples, the WTRU may receive a SS/PBCH block (SSB). The SSB may include a PSS, SSS, and a PBCH. The WTRU may monitor, receive, or attempt to decode an SSB during initial access, initial synchronization, RLM, cell search, cell switching, etc.

In examples, the WTRU may measure and report the CSI. The CSI may include or be configured with one or more of following: a CSI report configuration; a CSI-RS resource set, or NZP CSI-RS resources. The CSI report configuration may include one or more of the following: a CSI report quantity, (e.g., L1-RSRP, SNR, CQI, RI, PMI, CRI, LI, etc.); a CSI report type (e.g., aperiodic, semi persistent, periodic); a CSI report codebook configuration (e.g., Type I, Type II, Type II port selection, etc.) or a CSI report frequency. The CSI-RS resource set may include one or more of the following CSI resource settings: an NZP-CSI-RS resource for channel measurement; an NZP-CSI-RS resource for interference measurement; or a CSI-IM resource for interference measurement. The NZP CSI-RS resources may include one or more of the following: an NZP CSI-RS resource ID; a periodicity and offset; QCL info and TCI-state; or resource mapping (e.g., number of ports, density, CDM type, etc.).

In examples, a WTRU may receive one or more CSI report configurations (e.g., CSI-ReportConfig). A CSI report configuration may include a CSI report quantity that may indicate the CSI parameters that may be required to be measured, estimated, derived, and/or reported. In examples, CSI report quantity may be one or more of the L1-RSRP, CQI, RI, PMI, CRI, LI, or SINR.

The CSI report configuration may be associated with one or more CSI resource settings (e.g., CSI-ResourceConfig) for channel or interference measurement. A resource setting may include a list of CSI resource sets. The list of CSI resource sets may include references to one or more CSI-RS resource sets or SSB sets.

Examples of beam reporting with multiple beam resource sets are provided herein.

A WTRU may receive configuration information for multiple beam resource sets (e.g., M resource sets) for monitoring beams and potentially reporting them. Configurations may correspond to spatial domain beam predictions whereby a WTRU may report beam measurements (e.g., L1-RSRP measurements) of a large number of beams and indicate their best beam. Configurations may correspond to temporal domain beam prediction where a WTRU may report beam measurements over multiple time instances (e.g., consecutive time instances or alternative time instances or every T number of time instances (T≥1), etc.) and reporting time instances (e.g., each reporting time instance) the WTRU may (e.g., may also) report the best beam. Configurations received by the WTRU may include beam resource sets for both or one of spatial and/or temporal beam prediction. In either temporal or spatial beam prediction, the WTRU may report more than one best beam (e.g., a beam with highest L1-RSRP, a beam with second highest L1-RSRP, etc.). The WTRU may report the probability of being the best beam out of a configured set of beams.

For the one or more best beams at reporting instances (e.g., each reporting instance), if the reported best beam index is not associated with a measurement reference signal (e.g., the best beam index derived from measurements of reference signals associated with other beams), the WTRU may report a value of confidence level. The confidence level may range from 0 to 1 to indicate the confidence level. The confidence level value toward ‘0’ may imply that the prediction accuracy is unreliable while the confidence level value toward ‘1’ may imply that the prediction accuracy is reliable. If the reported best beam index is associated with a measurement reference signal, a WTRU may indicate the confidence level ‘1’.

A WTRU may be configured with multiple CSI-RS resource sets for beam reporting. For example, the nzp-CSI-RS-SSB of a CSI-ResourceConfig may be configured with multiple nzp-CSI-RS-ResourceSetLists. The resource sets may be configured in a way to reduce reporting overhead and enable the WTRU to report a smaller subset of beams.

The CSI-RS-ResourceSets may be configured by the network to ensure that beams within the resource set are ordered such that adjacent beams are correlated. For example, beams (e.g., all beams) in a CSI-RS-ResourceSet associated with the same sector and azimuth angle may be indexed based on an azimuth angle.

The CSI-RS-ResourceSets may be configured by the network such that beams within the resource set have similar beam measurements (e.g., L1-RSRP values). For example, resource sets (e.g., each resource set) may be configured with beam resources corresponding to a particular sector, panel, and/or elevation angle such that the beams are likely to have similar L1-RSRP values. Supporting beam indexing or beam ordering based on orientation or angles in this way may reduce the CSI reporting overhead.

A WTRU may report beam measurements for a subset of beam resource sets out of (e.g., all the) beam resource sets received from the network. WTRU selection of the beam resource sets may rely on one or more of the following: a beam measurement (e.g., L1-RSRP) based on a beam resource set determination; a differential beam measurement (e.g., differential L1-RSRP) based beam resource set determination; a variance based beat set determination; or a PUCCH/PUSCH based beam resource set determination.

For the beam measurement (e.g., L1-RSRP) based beam resource set determination, the WTRU may report beam measurements of the resource set where the beam with the highest beam measurement (e.g., L1-RSRP) was measured and/or the WTRU may simply report the beam with the highest beam measurement (e.g., beam index or beam ID).

For example, the WTRU may report beam measurements of resource sets (e.g., each resource set) with a maximum beam measurement (e.g., L1-RSRP) and/or an average beam measurement (e.g., average L1-RSRP) above a threshold preconfigured by a gNB. The WTRU may (e.g., may also) report the one or more beam with the highest or average beam measurement (e.g., highest or average L1-RSRP) above the preconfigured threshold (e.g., beam index or beam ID).

For example, the WTRU may report the highest beam measurement (e.g., highest L1-RSRP) per sector. The sectors may have been predefined or preconfigured by the gNB in the WTRU. In examples, sector 1 may correspond to beam indices 0-15, sector 2 to beam indices 16-31, and so forth. The sectors may (e.g., may also) be defined in terms of the azimuth angles. A change in the position of the WTRU beyond a preconfigured threshold may trigger reconfiguration of the sectors (e.g., via RRC (re)configuration).

For example, the WTRU may report beam measurements of the resource set where the beam with the lowest beam measurement (e.g., lowest L1-RSRP) was measured and/or the WTRU may simply report the beam corresponding to the lowest beam measurement (e.g., lowest L1-RSRP) (e.g., beam index or beam ID). This may be a one-shot reporting that may assist the network to discount or deprioritize that beam if configuring beam resources for future time instances. The WTRU may be configured to do a one-shot reporting of the sector, the elevation angle, and/or panel with the beam with the lowest beam measurement to assist the network to deprioritize that particular sector, elevation angle, and/or panel in future time instances if configuring beam resources for the WTRU. The network may (e.g., may also) use this information to deprioritize adjacent beams (e.g., to the beam with the lowest L1-RSRP).

For example, the WTRU may report average beam measurements per sector, elevation angle, and/or panel to the gNB to assist the gNB in configuring beam resources for future time instances. In examples, the gNB may not configure beam resources for the sector, elevation angle, and/or panel with the lowest reported beam measurement (e.g., lowest L1-RSRP measurements).

For the differential beam measurement (e.g., differential L1-RSRP) based beam resource set determination, the WTRU may report beam measurements for a subset of beam resource sets based on the differential beam measurement (e.g., L1-RSRP) from the previous measurement. For example, if the differential L1-RSRP from the previous measurement (e.g., measurement in the previous time instant) is above a preconfigured threshold, the WTRU may report the most recent beam measurements. In the case of spatial beam prediction, if the differential L1-RSRP between two adjacent beams out of the subset of beam resources that were previously reported exceeds a preconfigured threshold, the WTRU may report the most recent beam measurements. For example, the WTRU may report the absolute L1-RSRP of one beam (e.g., beam with the highest L1-RSRP) and differential L1-RSRP of up to a maximum of N additional beams (e.g., N=3) for the beam with the second highest L1-RSRP, third highest L1-RSRP measurements, and so forth.

For the variance based beam set determination, the WTRU may report beam measurements of the beam resource set including the beam with the maximum beam measurement (e.g., maximum L1-RSRP) and the resource set with a maximum beam measurement variance (e.g., maximum L1-RSRP variance) (e.g., if it is different from the resource set with the maximum beam measurement).

For the PUCCH/PUSCH based beam resource set determination, the WTRU may report beam measurements of a beam resource set based on the availability of PUCCH or PUSCH resources. For example, the WTRU may report L1-RSRP of the best one beam if a limited amount of PUCCH or PUSCH resources is available, or a L1-RSRP for the best N beams (N>1) if more PUCCH or PUSCH resources are available. For example, the WTRU may report L1-RSRP for the best beam per sector if additional PUCCH or PUSCH resources are available. For example, the WTRU may report beam measurements of the resource set with the maximum L1-RSRP at time instances (e.g., additional time instances) (e.g., increased reporting frequency) based on the availability of PUCCH or PUSCH resources.

The WTRU may be dynamically and/or semi statically indicated or configured by the network to report beam measurements of a subset of beam resources. For example, the WTRU may be configured to report beam measurements of a subset of beam resources at specific or predefined time intervals configured by the network. The WTRU may be indicated or configured with specific periodicities for reporting, explicit timings for reporting, and/or timing intervals from previous measurements when the WTRU would have to report (e.g., updated) measurements.

For example, the WTRU may be configured to report beam measurements of a subset of beam resources every time the WTRU performs measurements.

For example, the WTRU may be configured with thresholds corresponding to the L1-RSRP measurements such that a change in measurement with respect to the last measurement report for the subset of beams beyond a preconfigured threshold may trigger the WTRU to report beam measurements of the subset of beam resources.

For example, the WTRU may be configured to report L1-RSRP measurements for a subset of beam resources if there is a change in the beam with the highest L1-RSRP measurement. The WTRU (e.g., in that case) may be configured to report the beam (e.g., updated beam) with the highest L1-RSRP measurement (e.g., beam index, beam ID) and/or the L1-RSRP measurement.

For example, the WTRU may report beam measurements of a subset of beam resources on reception of an ad-hoc request to do so from the network.

A WTRU may be configured to report beam measurements of a subset of beam resources if AI/ML model performance goes below a threshold. The AI/ML model performance may be at least one of beam prediction accuracy, a number of consecutive NACKs, beam failure instance occurring N times, or a number of OoS (Out-of-Sync) from RLM measurement.

The WTRU may report multiple beam measurements of selected beam resource sets. For example, the WTRU may report L1-RSRP of the best beam (e.g., the beam with highest L1-RSRP measurement) and its CRI along with differential L1-RSRP of the rest of the beams the beam resource sets selection (e.g., for each of the beam resource sets selected).

The WTRU may report beam measurements of a subset of beam resource sets and report partial beam measurements or parameters associated with beam measurements of the remaining resource sets. For example, for the remaining resource sets, the WTRU may (e.g., may only) report L1-RSRP if above a preconfigured threshold, or the WTRU may report an average or median L1-RSRP of the beams (e.g., all the beams) in the resource set. For example, the WTRU may report beam measurements of resource set(s) associated with the sector, panel, and/or elevation angle currently serving the WTRU with higher reporting frequency. For the remaining resource sets (e.g., corresponding to remaining sectors or panels or elevation angles), the WTRU may report the CRI and L1-RSRP of the best beams with a lower reporting frequency. For example, partial L1-RSRP measurements may include one or more of the following: a CRI of beam with highest L1-RSRP measurement and the L1-RSRP; a number of beam resources with L1-RSRP above a threshold; or a median or average L1-RSRP of the beams in the beams resource set.

If a WTRU determines to report beam measurements of a subset of beam resources sets (e.g., as one or more triggering conditions are met), a WTRU may request an uplink resource to report the beam measurements of the subset of beam resource sets.

A WTRU may be configured (e.g., receive configuration information) or indicated to report beam (e.g., RS resource) measurements of a first number of resource sets (e.g., M>1) beam resources (e.g., RS resource) sets. The WTRU may report a configured first set of measurements for a selected second number of RS resource set(s) (e.g., S M) beam resource (e.g., RS resource) set(s)). The WTRU may determine the S beam resource (e.g., RS resource) sets based on beam (e.g., RS resource) measurements (e.g., a beam resource (e.g., RS resource) set may be selected for reporting beam (e.g., RS resource) measurements if the beam (e.g., RS resource) measurement (e.g., L1-RSRP) of at least one beam (e.g., RS resource) in the RS resource set a threshold configured by the gNB). For a third number of RS resource sets (e.g., the remaining RS resource sets or unselected number of the first number of RS resource sets), the WTRU may report a second set of measurements. The WTRU may not report any beam (e.g., RS resource) measurement of beams (e.g., RS resources) associated with RS resource sets not selected.

A WTRU may be configured (e.g., receive configuration information) to report RS resource measurements. The configuration information may include a first number of RS resource sets (e.g., M RS resource sets) and an RS resource set selection criterion.

The WTRU may receive configuration information or an indication for selecting a second number of RS resource set from the first number of RS resource sets (e.g., selecting S (M) RS resource sets out of M RS resource sets) based on the RS resource set selection criterion (e.g., select the S RS resource set(s) that includes the RS resource(s) with a maximum measurement value (e.g., L1-RSRP), or select the S RS resource set(s) with an average measurement value exceeding a preconfigured threshold).

The WTRU may perform RS resource measurements (e.g., L1-RSRP) for the first number of RS resource sets (e.g., M RS resource sets). The WTRU may determine (e.g., select) the second number of RS resource sets (e.g., value of S, and the S selected RS resource sets) for measurement reporting based on the configured RS resource set selection criteria.

The WTRU may report a first measurement type (e.g., per-RS resource L1-RSRP) for the second number of RS resource sets (e.g., S selected RS resource sets) and may report a second measurement type (e.g., per-RS-resource-set average L1-RSRP) for the third number of RS resource sets (e.g., (M-S)) (e.g., the unselected RS resource sets).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-10. (canceled)

11. A wireless transmit/receive unit (WTRU), the WTRU comprising:
a processor configured to:
receive configuration information, wherein the configuration information comprises a first number of reference signal (RS) resource sets and an RS resource set selection condition;
receive an indication for selecting a second number of RS resource sets from the first number of RS resource sets for measurement reporting based on the RS resource set condition;
perform a respective RS resource measurement for each RS resource within the first number of RS resource sets;
select the second number of RS resource sets for measurement reporting based on the RS resource set condition; and
report a first measurement type for the second number of RS resource sets and a second measurement type for a third number of RS resource sets, wherein the third number of RS resource sets is a number of RS resource sets not selected from the first number of RS resource sets.

12. The WTRU of claim 11, wherein the RS resource set condition is selecting the second number of RS resource sets based on the second number of RS resource sets including at least one RS resource with a maximum measurement value.

13. The WTRU of claim 11, wherein the RS resource set condition is selecting the second number RS resource sets based on the second number of RS resource sets having an average measurement value that exceeds a preconfigured threshold.

14. The WTRU of claim 11, wherein the first measurement type comprises reference signal received power (RSRP) measurements for each RS resource within an RS resource set.

15. The WTRU of claim 11, wherein the second measurement type comprises an average RSRP measurement for all RS resources within an RS resource set.

16. A method associated with a wireless transmit/receive unit (WTRU), the method comprising:
receiving configuration information, wherein the configuration information comprises a first number of reference signal (RS) resource sets and an RS resource set selection condition;
receiving an indication for selecting a second number of RS resource sets from the first number of RS resource sets for measurement reporting based on the RS resource set condition;
performing a respective RS resource measurement for each RS resource within the first number of RS resource sets;
selecting the second number of RS resource sets for measurement reporting based on the RS resource set condition; and
reporting a first measurement type for the second number of RS resource sets and a second measurement type for a third number of RS resource sets, wherein the third number of RS resource sets is a number of RS resource sets not selected from the first number of RS resource sets.

17. The method of claim 16, wherein the RS resource set condition is selecting the second number of RS resource sets based on the second number of RS resource sets including at least one RS resource with a maximum measurement value.

18. The method of claim 16, wherein the RS resource set condition is selecting the second number RS resource sets based on the second number of RS resource sets having an average measurement value that exceeds a preconfigured threshold.

19. The method of claim 16, wherein the first measurement type comprises reference signal received power (RSRP) measurements for each RS resource within an RS resource set.

20. The method of claim 16, wherein the second measurement type comprises an average RSRP measurement for all RS resources within an RS resource set.
